(19) United States
(12) Patent Application Publication
(10) Pub. No.: US 2002/0171898 A1
(43) Pub. Date: Nov. 21, 2002

(54) Method and apparatus for using strategically located reflectors to create pathways for networking of line-of-sight computing devices

(76) Inventor: Charles Milan Patton, Eugene, OR (US)

Correspondence Address: TESTA, HURWITZ & THIBEAULT, LLP, HIGH STREET TOWER, 125 HIGH STREET, BOSTON, MA, 02110, US

(21) Appl. No.: 10/021,221

(22) Filed: Dec. 6, 2001

Related U.S. Application Data
(60) Provisional application No. 60/291,200, filed on May 15, 2001.

(51) Int. Cl. H04B 10/20; H04J 14/00; H04B 10/00

(52) U.S. Cl. 359/172; 359/118

(57) ABSTRACT

In one aspect, the invention relates to a system of free-space electromagnetic pathways for facilitating wireless networking of a plurality computing devices, where each computing device has a transceiver for beamed line-of-sight, electromagnetic communication, the communication channel. The system includes a first location, a second location and a reflective surface. The first location is an area where one of the plurality of computing devices is used. The second location is an area where another of the plurality of computing devices is used. The reflective surface is purposely disposed adjacent the first and second locations such that a beamed communication transmitted from the first location is reflected in a direction towards the second location.

### RELATED APPLICATION

This application claims the benefit of the filing date of co-pending U.S. Provisional Application Serial No. 60/291,200, filed May 15, 2001, entitled “Method for Controlling Classroom Communications Over a Wireless Network”, the entirety of which provisional application is incorporated by reference herein.

### BACKGROUND

Wireless computing devices sometimes use light in the infrared wavelength region to communicate with each other. Because infrared is a near-optical frequency, it does not transmit through objects. Consequently, infrared communication typically requires the two communicating wireless devices to be pointed at one another, often referred to as point-to-point or line-of-sight communication.

In an environment where a plurality of users face substantially the same direction, for example, a classroom, passing data from one computing device with an infrared transceiver (e.g., personal digital assistant (“PDA”) and laptop computer) to a neighbor computing device with an infrared transceiver is cumbersome. Passing data typically requires the neighboring users to point their devices toward each other. If one user needs to pass data to another user who is sitting six users away in the same row, every user sitting in between might need to aim their devices, first to the neighbor on one side and then to the neighbor on the other side. Consequently, performing such an operation would be extremely disruptive and distracting to each of the students involved, to the professor giving the lecture and to the other students not involved with the data transfer.

### SUMMARY OF THE INVENTION

The invention facilitates a networked communication between line-of-sight computing devices without the need for the devices to face one another. The invention, in one embodiment, provides a reflective surface in front of the student so that the device, with the IR transceiver facing forward towards the reflective surface, can transmit to a neighboring device, also facing forward.

In one aspect the invention relates to a method for providing a system of free-space electromagnetic pathways to facilitate wireless networking of computing devices, where each computing device has a line-of-sight transceiver. The method comprises attaching a reflector to a surface of an object to create a reflective surface such that a beamed communication sent from a line-of-sight transceiver at a first location is reflected in a direction towards a second line-of-sight transceiver at a second location. In one embodiment, the method further includes providing a first location within the system adjacent the reflector for a user of a first computing device and providing a second location within the system adjacent the reflector for a user of a second computing device.

In another embodiment, where the reflector is a first reflector, the method further comprises attaching a second reflector to a surface of a second object to create a reflective surface such that the beamed communication received by the second transceiver and subsequently re-transmitted is reflected in a direction towards a third line-of-sight transceiver at a third location. In another embodiment, the method also includes providing a third location within the system adjacent the second reflector for a user of a computing device.

In another embodiment, the step of attaching further comprises attaching the reflector so that it has a curvature that disperses the beamed communication such that the second line-of-sight transceiver and a third the line-of-sight transceiver can receive the beamed communication. In another embodiment, the method includes transmitting the beamed communication using multicast packets. In another embodiment, the method includes transmitting the beamed communication in accordance to a multi-hop protocol.

In another embodiment, the method includes providing the reflector that conforms to a curvature of the surface of the object. In another embodiment, the method includes providing the reflector shaped to produce a predefined curvature on the surface of the object.

In another embodiment, the step of providing the reflector further comprises providing the reflector with the predefined curvature being arcuate.

In another embodiment, the method includes transmitting the beamed communication using light with an infrared wavelength. In another embodiment, the method includes using the computing device that is a personal digital assistant. In another embodiment, the attaching step further comprises attaching the reflector to a chair.

In another aspect, the invention relates to a system of free-space electromagnetic pathways for facilitating wireless networking of a plurality computing devices, where each computing device has a transceiver for beamed line-of-sight, electromagnetic communication, the communication channel. The system includes a first location, a second location and a reflective surface. The first location is an area where one of the plurality of computing devices is used. The second location is an area where another of the plurality of computing devices is used. The reflective surface is purposely disposed adjacent the first and second locations such that a beamed communication transmitted from the first location is reflected in a direction towards the second location.

In another embodiment, the system includes a third location at which another of the plurality of computing devices is used and a reflective surface purposely disposed adjacent the second and third locations such that the beamed communication received at and re-transmitted from the second location is reflected in a direction towards the third location. In another embodiment, the beamed communication uses a multicast packet. In another embodiment, the beamed communication traverses the network in accordance to a multi-hop protocol.

In another embodiment, the reflective surface has a curvature that disperses the beamed communication such that the beamed communication transmitted from the first location is received at the second location and the third location. In another embodiment, the reflective surface conforms to a curvature of a surface of an object to which the reflective surface is attached. In another embodiment, the reflective surface is shaped to produce a predefined curvature on a surface of an object to which the reflective surface is attached. In another embodiment, the predefined curvature of the reflector is arcuate. In another embodiment, the object is a chair.

In another embodiment, the beamed communication uses light with an infrared wavelength. In another embodiment, the beamed communication uses microwaves. In another embodiment, the computing devices are personal digital assistants.

In another aspect, the invention relates to a wireless network of line-of-sight computing devices. The network includes a first computing device, a second computing device and a reflector. The first computing device has a line-of-sight transceiver. The second computing device has a line-of-sight transceiver. The reflector is attached to a surface of an object adjacent the first and second computing devices such that a beamed communication sent from the transceiver of the first computing device is reflected in a direction towards the transceiver of the second computing device.

In another embodiment, the wireless network includes a third computing device having a line-of-sight transceiver and a second reflector attached to a surface of a second object adjacent the second computing device such that the beamed communication received by the second computing device and subsequently re-transmitted by the second computing device is reflected in a direction towards the transceiver of the third computing device.

### BRIEF DESCRIPTION OF THE DRAWINGS

The above and further advantages of the invention may be better understood by referring to the following description taken in conjunction with the accompanying drawing, in which:

FIG. 1 is a block diagram of a top view of an illustrative embodiment of a system of free-space electromagnetic pathways, constructed in accordance with the invention, for facilitating networking of computing devices, including line-of-sight transceivers, where the transceivers of each device are not within the line-of-sight of each other;

FIG. 2 is a block diagram of a side view of another illustrative embodiment of a system of free-space electromagnetic pathways, constructed in accordance with the invention, for facilitating networking of computing devices;

FIGS. 3A and 3B are a side view and a top view, respectively, of an illustrative embodiment constructed in accordance with the invention;

FIGS. 4A and 4B are a side view and a top view, respectively, of another illustrative embodiment of a reflector constructed in accordance with the invention;

FIGS. 5A and 5B are a side view and a top view, respectively, of another illustrative embodiment of a reflector constructed in accordance with the invention;

FIG. 6 is a block diagram of a top view of another illustrative embodiment of a system of free-space electromagnetic pathways, constructed in accordance with the invention, for facilitating networking of computing devices;

FIG. 7 is a conceptual diagram of a multicast packet hop layer used by each of the computing devices in a wireless network;

FIG. 8 is an exemplary process by which a computing device determines the local connectivity number;

FIGS. 9A-9E illustrates exemplary processes by which a computing devices within proximity of each other determine connectivity number;

FIG. 10 shows an exemplary process by which a computing device determines whether to reply to a query; and

FIGS. 11A-11B show an exemplary process by which a computing device determines whether to repeat a received packet.

### DETAILED DESCRIPTION

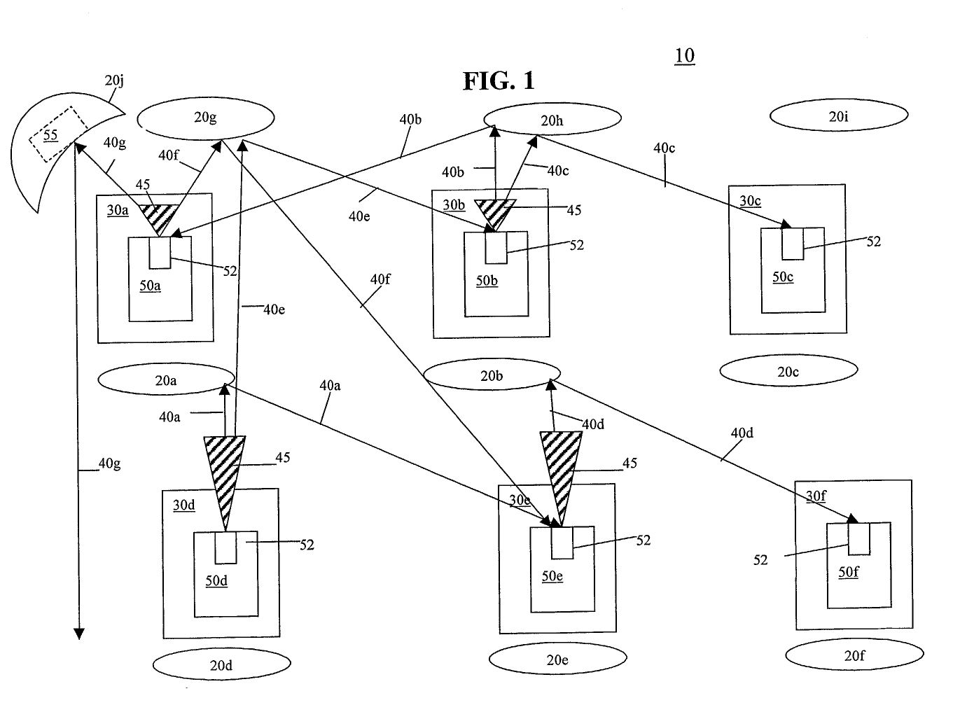

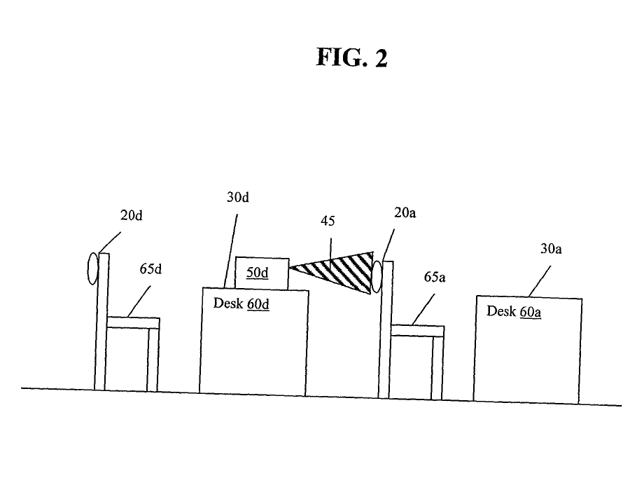

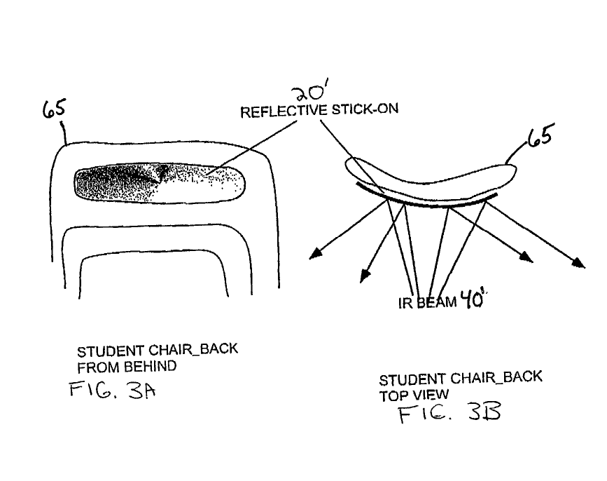

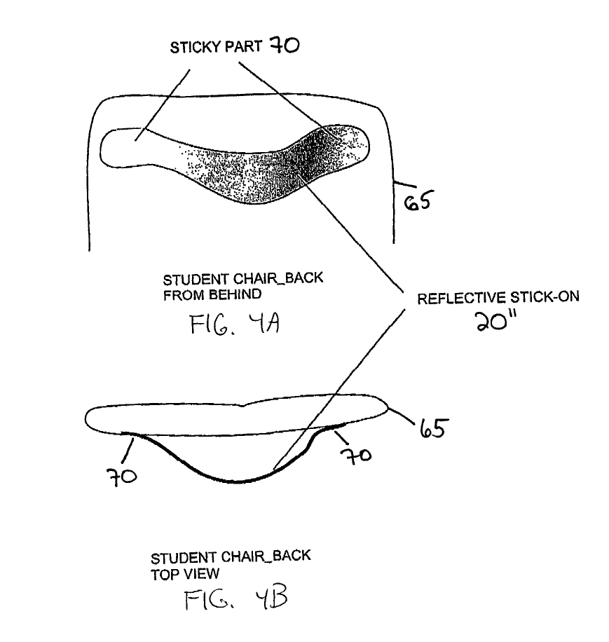

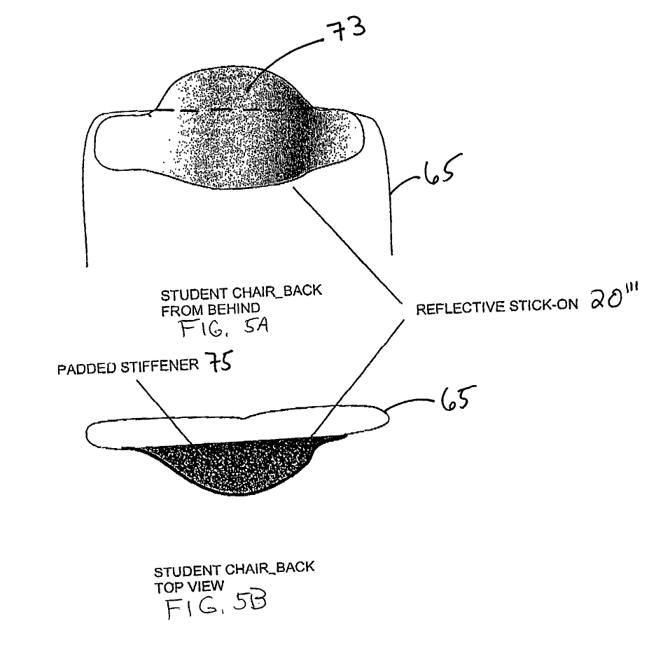

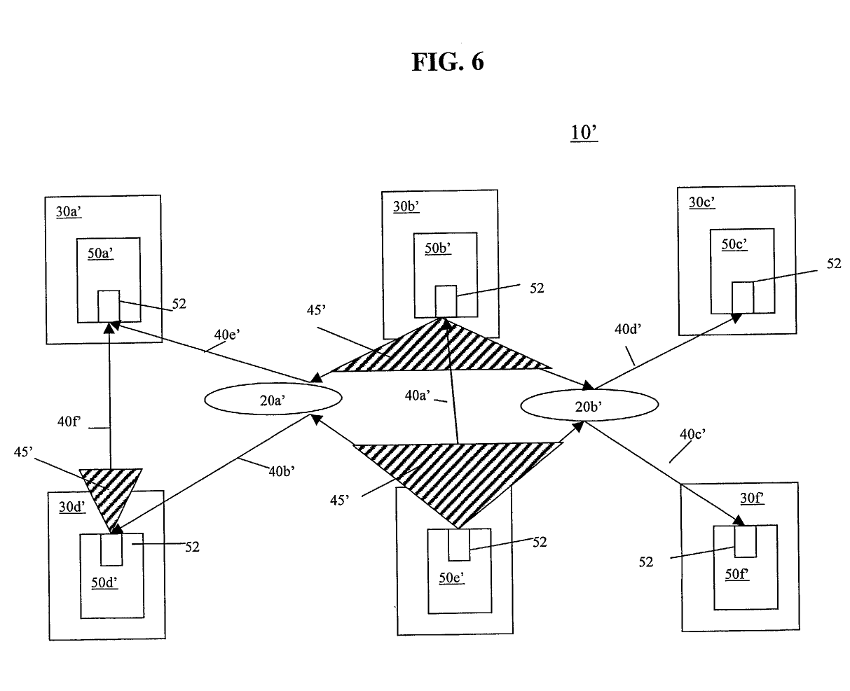

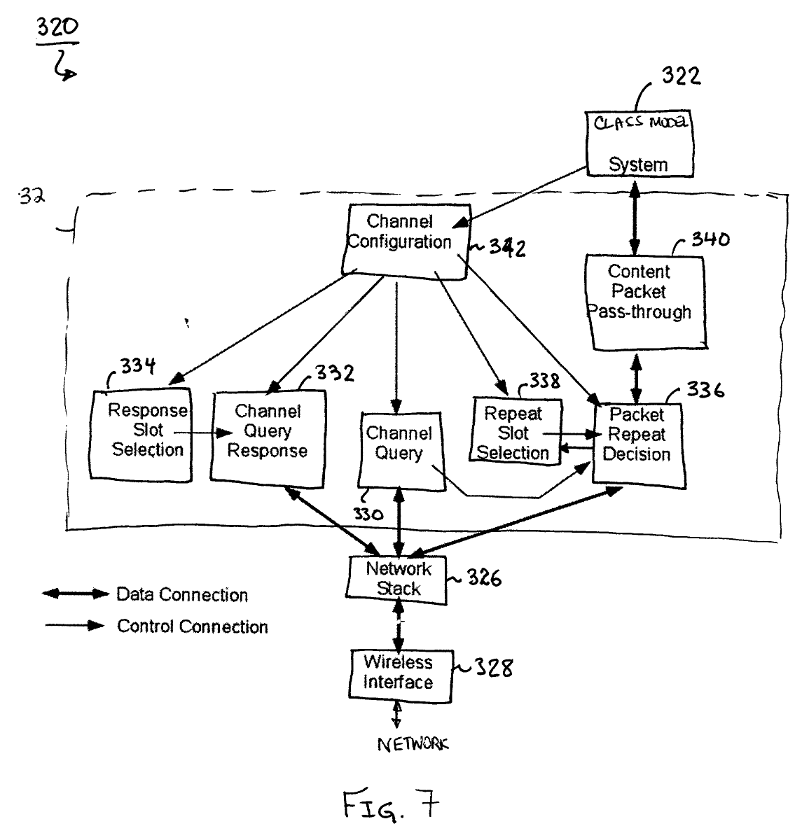

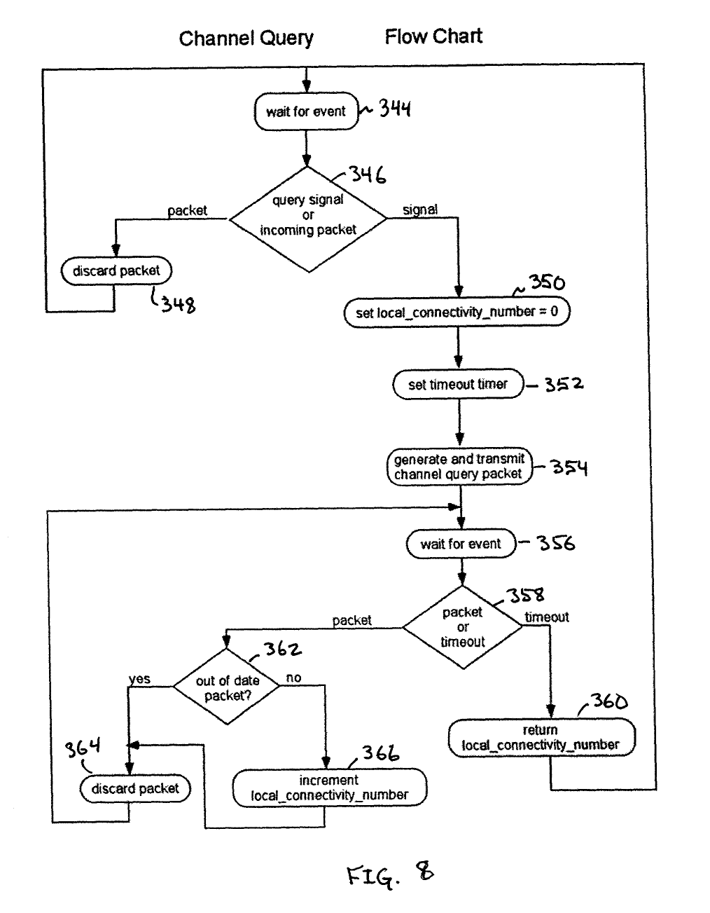

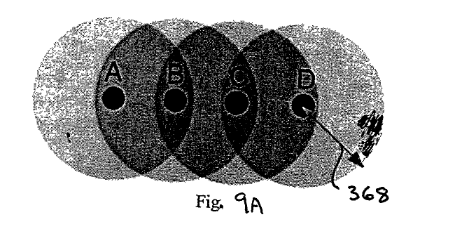

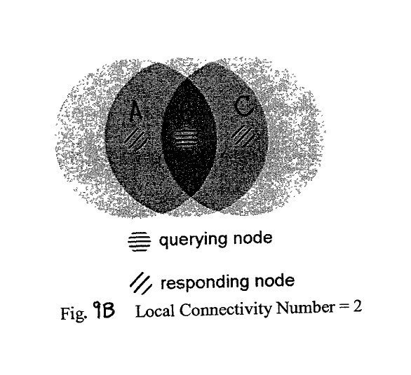

FIG. 1 illustrates a system 10 of free-space electromagnetic pathways 40 from a top view embodying the principles of the invention. The system 10 includes one or more reflective surfaces (also referred to as reflectors) 20a, 20b, 20c, 20d, 20e, 20f, 20g, 20h, 20 and 20j, generally referred to as reflector 20, one or more locations 30a, 30b, 30c, 30d, 30e, and 30f, generally referred to as location 30 and one or more free-space electromagnetic pathways 40a, 40b, 40c, 40d, 40e, and 40f, generally referred to as path 40. A path 40 represents how a beamed communication 45 (e.g., infrared beam) travels, emanating from one location 30 and impinging upon another location 30. The placement of the reflective surfaces 20 determines the paths 40.

A reflective surface 20 is purposely disposed adjacent the locations 30 such that a transmitted beamed communication 45 follows a path 40, starting from a first location 30 and being reflected in a direction towards a second location 30. For example, the reflective surface 20a is purposely disposed adjacent the locations 30d and 30e such that a beamed communication 45 travels along path 40a, the communication path 40a originating from the location 30d and reflecting off reflective surface 20a in a direction towards the location 30e.

In the embodiment illustrated in FIG. 1, the system 10 of free-space electromagnetic pathways 40 facilitates the networking of a plurality of computing devices 50a, 50b, 50c, 50d, 50e, and 50f, generally referred to as device 50. The computing device 50 can be, for example, a PDA (personal digital assistant), a laptop computer, a calculator, a watch and the like. In one embodiment, the computing device 50 includes a line-of-sight transceiver 52 for a beamed electromagnetic communication 45. The electromagnetic communication 45 can be, for example, light, point-to-point microwave energy and the like. Light communications can use various wavelengths, for example infrared wavelengths.

In the illustrated embodiment, a location 30 is an area within the system 10 established for a user to use a computing device 50. For example, in an embodiment where the system 10 is located within a classroom, a location 30 is the top of a student desk. In an embodiment where the system 10 is located within a conference room, a location 30 is an area adjacent to where a participant would rest his computing device 50. Beamed communications 45 are transmitted from or received by computing devices 50 at the locations 30 along communication paths 40a, 40b, 40c, 40d, 40e, and 40f, generally referred to as path 40.

If the transceivers 52 of the computing devices 50 are line-of-sight transceivers, the beamed communications 45 should not be obstructed. As shown, the transceivers 52 of all of computing devices 50 face substantially in the same direction. Typically, the computing devices 50 would have to be pointed to face each other to transmit and receive beamed communications 45. The system 10 facilitates networking by providing paths 40 over which the beamed communications 45 can travel between devices 50, although the computing devices 50 remain facing in substantially the same direction. As shown, the computing device 50b transmits a beamed communication 45 along path 40b to another computing device 50a by reflecting the beamed communication 45 off of the reflective surface 20h. The reflective surface 20h has been purposely located adjacent to the location 30b at which the computing device 50b is located and adjacent to the location 30a at which the computing device 50a is located. The placement of the reflective surface 20h creates multiple paths 40, including path 40b, which allows a line-of-sight beamed communication 45 without facing the two devices 50a, 50b at each other.

Additionally, the system 10 enables a computing device 50 to transmit a beamed communication 45 to more than one other computing device 50 at the same time. As shown, the computing device 50b transmits a beamed communication 45 along path 40b to computing device 50a and along path 40c to computing device 50c by reflecting the beamed communication 45 off of the reflective surface 20h. Further, with the addition of reflective surfaces 20g and 20i, computing devices 50a and 50c can re-transmit the received beamed communication 45. The re-transmitted beamed communications 45 reflect off of reflective surfaces 20g and 20i, and two additional computing devices (not shown) on the left of computing device 50a and on the right of computing device 50c receive the re-transmitted beamed communication 45. The computing devices 50 can re-transmit the beamed communications 45 using a variety of protocols, as described in more detail below.

Similarly, the placement of reflective surfaces 20a and 20b allow computing device 50d to transmit a beamed communication 45 to computing device 50f using paths 40a and 40d. To complete this task, computing device 50d transmits the beamed communication 45 along path 40a, which is reflected from reflective surface 20a to computing device 50e. Computing device 50e receives the beamed communication 45 traveling along path 40a. Computing device 50e re-transmits the beamed communication 45 along path 40d, which is reflected from reflective surface 20b to computing device 50f.

A communication path 40 for a beamed communication 45 is not necessarily limited to be between locations 30 of neighboring computing devices 50 in the same row (e.g. 50d, 50e, 50f). As illustrated, computing device 50d transmits the beamed communication 45 along path 40e, which is reflected from reflective surface 20g to computing device 50b, located in another row. Similarly, computing device 50a transmits the beamed communication 45 along path 40f, which is reflected from reflective surface 20g to computing device 50e.

The possible combinations of transmitting devices 50 and receiving devices 50 vary depending on several factors. These factors can be, for example, the transceiver 52 design, the type of electromagnetic energy carrying the beamed communication 45, the placement of reflective surfaces 20 and computing devices 50, and any obstructions to the beamed communications 45. For example, in the illustrated embodiment of FIG. 1, the locations 30a, 30b and 30c in one row are skewed, or offset, from the locations 30d, 30e and 30f of another row. In other embodiments, the locations 30 of one row are lined up with the locations of another row, one being directly behind the other.

One embodiment of a system 10 of free-space electromagnetic pathways 40 includes a reflective surface 20 placed at an end of a row, located so that a beamed communication 45 travels along a path 40 to another row that is in front of and/or behind the row of the transmitting computing device 50. For example, computing device 50a transmits the beamed communication 45 along path 40g, which is reflected from reflective surface 20j, located at the end of the row to a computing device 50, located in another row (not shown). In another embodiment, the reflective surface 20j includes an optional transceiver/repeater 55. 11Q This repeater 55 receives the beamed communication 45 and re-transmits it, as a strengthened signal, along a path 40 that travels a farther distance than the transceiver 52 of a computing device 50 is able to cause the beamed communication 45 to travel.

FIG. 2 illustrates a side view embodying the principles of the invention of two exemplary locations 30 in the system 10. This system 10 includes a plurality of desks, 60a and 60b, generally referred to as desk 60 and a plurality of chairs, 65a and 65b, generally referred to as chair 65, corresponding to the desks 60. Locations 30 are the tops of the desks 60 and, consequently, that is where a user places the computing device 50d. In the typical classroom layout, the chairs 65 in one row are situated in front of the locations 30 of another row.

To create a reflective surface 20a for a communication path 40 for use by computing device 50d, a reflector 20a is attached to the chair 65a, which is adjacent location 30d. Similarly, to create another communication path 40 for use by a computing device (not shown) behind chair 65d, a reflector 20d is attached to the chair 65d. Although a chair 65 is a convenient object in the classroom upon which to attach a reflector 20, other objects can be used. For example, the reflector 20 can be attached to a user sitting in the chair 65, including articles of the user's clothing, for example a shirt, a shirt collar or a hat, or parts of the user's body, for example the back of his neck or head. Other objects in the classroom can also be used, such as desks 60, walls and the like.

FIGS. 3A and 3B are a side view and a top view, respectively, of an illustrative embodiment of a reflector 20′ that is attached to a chair 65. The back of this chair 65 is curved. In this embodiment, the reflector 20′ is made of a flexible material that conforms to the shape of the chair. Consequently, by attaching the reflector 20′ to the back of the chair 65, the reflective surface 20′ adopts the curvature of the back of the chair 65. As illustrated in FIG. 3B, this curvature enables one beamed communication 45′ to be reflected at several different angles, permitting the beamed communication to be sent concurrently to many different locations along many different paths 40.

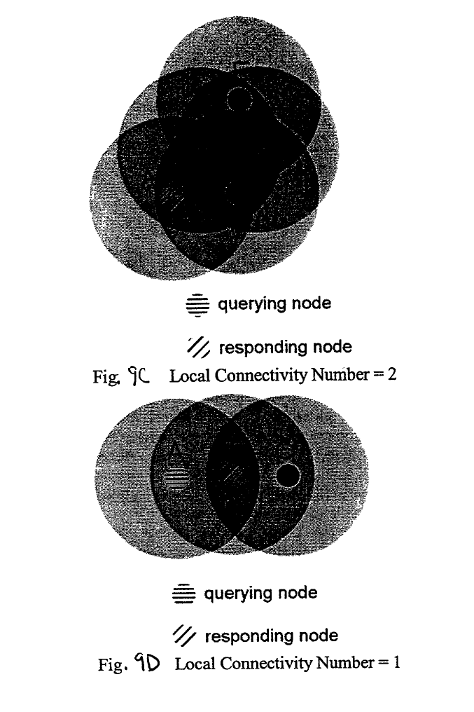

FIGS. 4A and 4B are a side view and a top view, respectively, of another illustrative embodiment of a reflector 20″ that is attached to a chair 65. The back of this chair 65 can be curved or can be substantially flat. In one embodiment, the reflector 20″ is made of a flexible material. In this embodiment, the reflector 20″ has adhesive on one side at its two ends 70. Consequently, by attaching the ends 70 of the reflector 20″ to the back of the chair 65, the reflective surface 20″ adopts a curvature based on the how close one end 70 is to the other end 70. Thus, the installer of the reflector 20″ conform the extent of the curvature as needed, based on the distances of the adjacent locations and on any other factors for which the installer wants to compensate. In another embodiment, the reflector 20″ is made of a rigid material and its curvature is predefined. This embodiment ensures a consistent curvature regardless of the curvature of the back of the chair 65 and regardless of the accuracy of the installer attaching the reflector 20c′ to the back of chair 65 using the adhesive ends 70.

FIGS. 5A and 5B are a side view and a top view, respectively, of another illustrative embodiment of a reflector 20′″ that is attached to a chair 65. Similarly as described with FIGS. 4A and 4B, in different embodiments the back of this chair 65 can be curved or can be substantially flat and the reflector 20′″ can made of a flexible material or a rigid material. In the embodiment of FIGS. 5A and 5B, the reflector 20′″ includes a portion 73 that extends above the top of the back of the chair 65. Consequently, by attaching the reflector 20′″ to the back of the chair 65, the height of the reflective surface 20′″ is extended as necessary for use by the adjacent locations 30 and any other factors for which the extended portion 73 compensates. In another embodiment, the reflector 20′″ includes a padded stiffener 75 to achieve a desired curvature.

Although FIGS. 1 and 2 illustrate system 10 of free-space electromagnetic pathways 40 where the computing devices 50 all face substantially in the same direction, communication pathways 40 can be established in other systems also. FIG. 6 illustrates the top view of an embodiment of a system 10′ in which some computing devices 50′, users of those computing devices 50′ and/or locations 30′ face substantially in the same direction and others face each other. This system 10′ can be within, for example, a conference room. The locations 30a′, 30b′ and 30c′ represent one side of a table within the conference room. The locations 30d′, 30e′ and 30f′ represent the another side of the table. With the system 10′, a single computing device 50e′ can transmit a line-of-sight beamed communication 45′ to all of the other computing devices 50′ at the same time. Computing device 50e′ can accomplish this, even though not all of the transceivers 52′ of the other computing devices 50′ are within the line-of-sight of the transceiver 52′ of the computing device 50e′.

The system 10′ includes the reflective surface 20a′, which is disposed adjacent locations 30a′, 30b′, 30d′ and 30e′, and the reflective surface 20b′, which is disposed adjacent locations 30b′, 30c′, 30e′ and 30f′. The reflective surfaces 20a′ and 20b′ create a plurality of paths 40′ within the system 10′ along which beamed communications 45′ can travel between all of the locations 30′. Using the paths 40′, a beamed communication 45′ from one computing device 50′ is transmitted to all of the other computing devices 50′ within the system 10′ of free-space electromagnetic pathways 40′ to create a wireless network.

For example, computing device 50e′ transmits a beamed communication 45′ along path 40a′ to computing device 50b′. At the same time, the beamed communication 45′ is reflected from reflective surface 20a′ along path 40b′ and received by computing device 50d′, and reflected from reflective surface 20b′ along path 40c′ and received by computing device 50f′. Across the table, computing device 50b′ receives the beamed communication 45′ along path 40a′ and re-transmits it. The re-transmitted beamed communication 45′ is reflected from reflective surface 20b′ along path 40d′ and received by computing device 50c′. The re-transmitted beamed communication 45′ is also reflected from reflective surface 20a′ along path 40e′ and received by computing device 50a′. Alternatively, computing device 50d′ can transmit the re-transmitted beamed communication 45′ along path 40f′ to computing device 50a′.

To create a wireless network using a system 10 of free-space electromagnetic pathways 40, the computing devices 50 determine whether to re-transmit the received beamed communication 45. The protocol for receiving a beamed communication 45 and determining whether to re-transmit it is referred to as a multi-hop protocol. In one embodiment of a multi-hop protocol, the re-transmission is automatic, except, for example, a limitation on the number of times the same beamed communication 45 is received and re-transmitted, so an infinite loop is avoided. Other embodiments can use other rules and/or protocols. The computing devices 50 can use, for example, the multi-hop protocols as defined in detail in United States patent application identified with attorney docket number SRI-012, filed Nov. 16, 2001, incorporated herein by reference.

In classroom environments, one exemplary multi-hop protocol for communicating among computing devices 50 (referred to also as nodes 50) can be referred to as multicast packet hop (or “Hip Hop”). The use of multicast addresses can accomplish the exchange of information among nodes 50 without using routing tables, without needing to determine actual routes from IP addresses, and without using an IP address to identify a person with a computing device 50. The multicast packet hop enables multi-hop, multicast communications in the wireless network pathways 40 without such routing support. In brief overview, each computing device 50 that receives an incoming multicast packet in a beamed communication 45 decides whether to re-issue that packet (e.g., retransmit the beamed communication 45 over the pathways 40). One reason for re-issuing the packet is if the computing device 50 can determine that another computing devise 50 connected via a path 40 is interested in the packet and has not yet received the packet.

FIG. 7 shows a conceptual diagram of a multicast packet hop layer used by each of the nodes 50 in the network to propagate packets through the network. Although a variety of networking mechanisms can be used in service of transporting data, the multicast packet hop layer is particularly suited to the needs and circumstances associated with a classroom environment. Those needs and circumstances include:

the participating nodes 50 are typically in close proximity to one another (i.e., under 2 meters to the nearest neighboring node 50),

the classroom environment is relatively isotropic; that is, the environment is approximately the same in every direction in that the number and distribution of neighboring participants is approximately the same for each participant,

the number of participants (teacher and students) is typically small and fixed,

geographically proximal nodes 50 are likely to be participants working on closely related tasks with significant amounts of common data,

participating nodes 50 typically have very low processing capabilities,

participating nodes 50 have stringent power requirements,

uniform usage of power across the participating nodes 50 is as important as total power consumption,

the number of participating nodes 50, although variable, has a quite limited range-from a few to a few tens of nodes 50, to, possibly, several hundred, but typically not more, and

support for node to node 50 communication independent of the data delivery as described herein is of low priority.

The multicast packet hop layer includes channel management software 324, which provides an interface with the transceiver 54 of a computing device 50 capable of carrying IP multicast packets. Components of the channel management software 324, in one embodiment, include a channel query component 330, a channel query response component 332, a response slot selection component 334, a packet repeat decision component 336, a repeat slot selection component 338, a content packet pass through component 340, and a channel configuration component 342.

The channel management software 324 is in communication with a network stack 326. Data flows to and from the wireless network through the wireless interface 328 (e.g., transceiver 52) and the network stack 326. The network stack 326 is capable of sending and receiving arbitrary IP multicast packets to and from the wireless interface 328. The network stack 326 also exchanges data with the channel query response component 332, channel query component 330, and the packet repeat decision component 336.

The packet repeat decision component 336 receives control instructions from the channel configuration component 342, channel query component 330, and the repeat slot selection component 338, sends control instructions to the repeat slot selection component 338, and exchanges data communications with the content packet pass through component 340. The content packet pass through component 340 operates as a filter of packets passing to and from other layers of the communication software stack. Although shown to be part of the multicast packet hop layer 320, the content packet pass through component 340 can be a software component that operates at another layer of the protocol stack. For example, in one embodiment, the content packet pass through component 340 operates as a contract layer.

In one embodiment, a multicast address is associated with a particular data context (e.g., homework). Using data supplied over a different mechanism (e.g., point-to-point beaming, verbal instructions), the channel configuration component 342 configures those nodes 50 that are involved in that particular data context to respond to the multicast address associated with that data context. (In contrast with standard IP multicast, every node 50 in the network can source data to a multicast address, and receive data packets addressed to that multicast address.)

For an activity having one data context only, only one multicast IP address is used in all transmissions and receptions of data. Thus, for each node 50 in the network, the routing of packets through the network reduces to determining, upon receipt of a packet, whether to repeat that packet.

To make this determination, each node 50 measures the local connectivity of the network, at configurable intervals, using the channel query component 330. In one embodiment, the channel query component 330 invokes the standard IP multicast ‘interest’ query and records the total number of responses that the node 50 receives. This number, hereafter referred to as the local connectivity number, is used by the packet repeat decision component 336, along with other information, to determine whether a received packet is to be repeated.

Other nodes 50, upon receiving the query, use the channel query response component 332 and the response slot selection component 334 to appropriately respond to the query. In particular, the channel query response component 332 transmits a response during a time slot determined by the response slot selection component 334 if the node 50 has not received a response from another node 50 before the node's 50 time slot occurs. In one embodiment, the channel query response component 332 invokes the standard IP multicast ‘interest’ channel query response and response slot selection mechanisms.

In one embodiment, the response slot selection component 334 chooses the time slot randomly upon each occurrence of a request for a time slot from the channel query response component 332. Thus, the amount of time that a particular node 50 waits before responding to a channel query varies from channel query to channel query. This variable delay distributes the power consumed by each of the nodes 50 to respond to channel queries—the random delay at each node 50 causes the nodes 50 to take turns transmitting a reply. This distribution of power consumption is particularly advantageous in a classroom where the computing devices 50 are battery-powered and, with all other factors being equal, reduces that likelihood that some computing devices 50 will run out power before others in the network.

In another embodiment, suitable for classrooms with few students (e.g., 2-30), the response slot is externally assigned—one per node 50 in the classroom, to avoid potential collisions between responding nodes 50. In this embodiment, the external assignment of response slots performs the function of the response slot selection component 334. The externally assigned slots can be periodically rotated among the nodes 50 so that no one node 50 bears more of the response burden than any other node 50.

FIG. 8 shows an embodiment of a process by which a node 50 determines the local connectivity number. In step 344, the channel query component 330 waits for an event to occur. For example, an event can be the arrival of a query response packet (which can be left over from previous query) or a signal from the channel configuration component 342 indicating that a recomputation of the local connectivity number is desired (e.g., on the basis of the expiration of a timer). Upon the occurrence of an event, the channel query component 330 determines whether (step 346) the event is an incoming query response packet or a signal to begin a new query. If the event is a packet, the node 50 discards (step 348) the packet. If the event is a query signal, the channel query component 330 sets (step 350) the local connectivity number equal to 0.

In step 352, the node 50 starts a local timeout timer. In step 354, the channel query component 330 generates and transmits a channel query packet. The node 50 then counts the number of responses to the channel query packet that occur before the timer times out. Accordingly, the channel query component 330 waits (step 356) for the occurrence of an event. Upon the occurrence of an event, the channel query component 330 determines (step 358) if the event is the timeout of the timer or the receipt of a packet.

In step 360, if the event is the timeout of the timer, the channel query component 330 returns the present value of the local connectivity number. In step 362, if the event is a packet, the channel query component 330 determines if the packet is out of date. The channel query component 330 discards (step 364) the packet if the packet is outdated, otherwise, increments (step 366) the local connectivity number. The channel query component 330 then waits (step 344) for the occurrence of the next event.

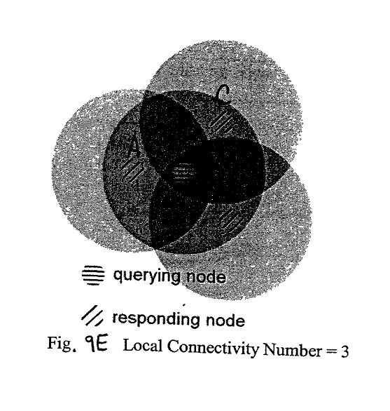

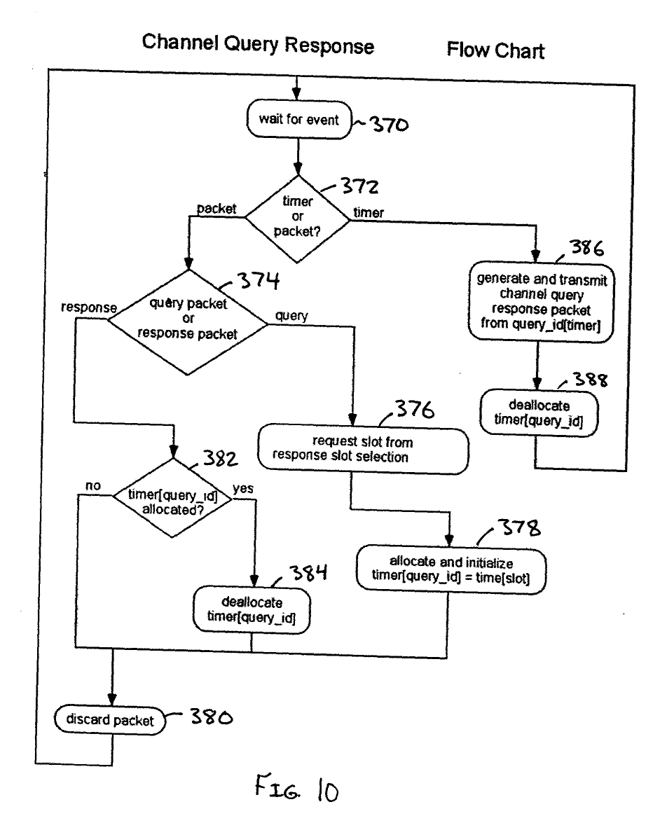

FIGS. 9A-9E illustrate various examples of computing the local connectivity number in several different exemplary network situations. FIG. 9A shows a diagram illustrating an embodiment in which four nodes 50 (A, B, C, and D) are within proximity of each other. Each node 50 has a line-of-sight range 368 within which that node 50 can directly transmit to and receiver from other nodes 50 beamed communications 45 over pathways 40 of the system 10. As shown by the overlapping line-of-sight ranges 368, node 50 A can communicate directly with node 50 B, node 50 B can communicate directly with nodes 50 A and 50 C, node 50 C can communicate directly with nodes 50 B and 50 D, and node 50 D can communicate directly with node 50 C.

FIG. 9B shows an example of computing the local connectivity number from the point of view of node 50 B. In this example, node 50 B is the querying node 50 and both nodes 50 A and 50 C respond to the query of node 50 B because both nodes 50 A and 50 C directly receive the query and neither node 50 A nor node 50 C can communicate directly with the other. Thus, the local connectivity number is 2.

FIG. 9C shows an example of computing the local connectivity number in a network with five nodes 50 A, 50 B, 50 C, 50 D, and 50 E. In this example, node 50 C is the querying node 50. Because the line-of-sight ranges 368 of nodes 50 A, 50 B, 50 D, and 50 E overlap the wireless range of node 50 C, each node 50 receives the query. In the network, node 50 B can also directly communicate with nodes 50 A and 50 D, but not with node 50 E. Node 50 E can also directly communicate with node 50 D, but not with nodes 50 A and 50 B. Accordingly, when node 50 A responds to the query (in this example, because the node 50 A's timer times out before node 50 B's timer) node 50 B does not reply to the query because node 50 B receives node 50 A's response before node 50 B's timer times out. Similarly, node 50 E does not reply to node 50 C's query, because node 50 E directly receives node 50 D's reply before node 50 E's timer times out (in this example, node 50 D's timer times out before node 50 E's timer). Consequently, node 50 C directly receives two replies, and therefore the local connectivity number from the perspective of node 50 C is 2.

FIG. 9D shows an example of computing the local connectivity number from the point of view of node 50 A. In this example, node 50 A is the querying node 50 and node 50 B responds to the query. Node 50 C does not respond to the query because node 50 C does not directly receive the query. Node 50 C receives node 50 B's reply, but discards the reply because the reply, from the perspective of node 50 C, is not associated with any known query. Even if node 50 C directly receives the query from node 50 A, if node 50 B responds first, node 50 C does not respond. Thus, the local connectivity number is 1.

FIG. 9E shows another example of computing the local connectivity number in a network with four nodes 50 A, 50 B, 50 C, and 50 D. In this example, node 50 B is the querying node 50. The line-of-sight ranges 368 of nodes 50 A, 50 C, and 50 D overlap the line-of-sight range 368 of node 50 B, thus each of these nodes 50 A, D and 50 D directly receives the query. In this example, node 50 A cannot directly receive beamed communications 45 from nodes 50 C and 50 D. Likewise, node 50 C cannot directly receive beamed communications 45 from nodes 50 A and 50 D, and node 50 D cannot directly receive beamed communications 45 from nodes 50 A and 50 C. Accordingly, each of the nodes 50 A, 50 C, and 50 D respond to node 50 B, and therefore the local connectivity number from the perspective of node 50 B is 3.

The embodiments depicted in FIGS. 9A-9E have symmetrical pathways 40 because a transmitting node 50 that can directly transmit a beamed communication 45 from receiving node 50 can also directly receive a beamed communication 45 back from that receiving node 50. In other embodiments, the pathways 40 are not symmetrical. For example, a computing device 50 can have a transmitter in the front and a receiver in the back. In such an embodiment, additional reflective surfaces 20 can be added to make the system 10 of pathways 40 equivalent to an embodiment where the pathways 40 are symmetrical. In other embodiments, the beamed communication 45 of each of the computing devices 50 can vary. This can create some asymmetrical pathways 40. In these embodiments, and others where not all of the pathways 40 are symmetrical, the calculated local connectivity number will be lower.

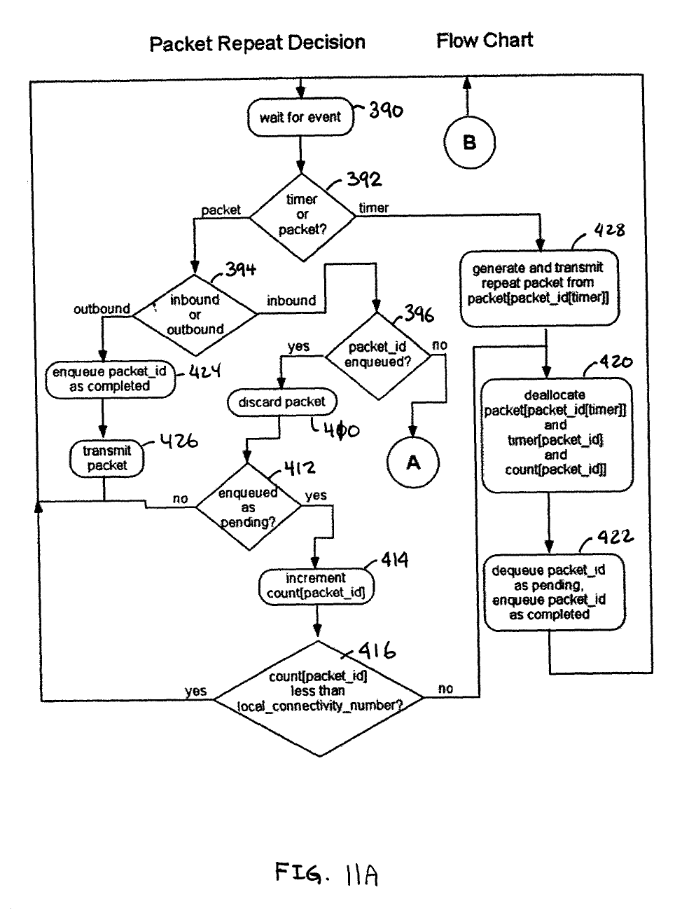

FIG. 10 shows an embodiment of a process by which a node 50 determines whether to reply to a query. In step 370, the channel query response component 332 waits for an event. Upon the occurrence of an event, the channel query response component 332 determines (step 372) if the event is the timeout of the timer or the receipt of a packet.

If the event is a packet, the channel query response component 332 determines (step 374) if the packet is a query packet or a response packet.

If the event is a query packet, the channel query response component 332 requests (step 376) a response slot from the response slot selection component 334.

In step 378, the channel query response component 332 then allocates a time slot and initializes the timer (e.g., timer[query_id]=time[slot], where query_id is a value assigned to identify the query packet, timer[query_id] is the timer associated with the query packet, and time[slot] is the time when the node 50 is to respond to the query packet if the node 50 does not hear another response). The channel query response component 332 then discards (step 380) the query packet.

If the event is a response packet, the channel query response component 332 determines (step 382) if a time slot (timer[query_id]) has been allocated. If so, the node 50 has heard a response to a query that the node 50 also heard, but no longer needs to respond to because another node 50 responded first. Accordingly, the channel query response component 332 deallocates (step 384) the time slot and discards (step 380) the response packet. If a time slot has not been allocated, the node 50 has heard a response to a query that the node 50 itself has not heard. Accordingly, the channel query response component 332 discards (step 380) the response packet.

If, in step 372, the event is the timeout of the timer, the node 50 has not heard a response to the query from another node 50. Thus, the channel query response component 332 generates and transmits (step 386) a channel query response packet from query_id[timer], deallocates (step 388) the timer[query_id], and then waits (step 370) for the occurrence of the next event.

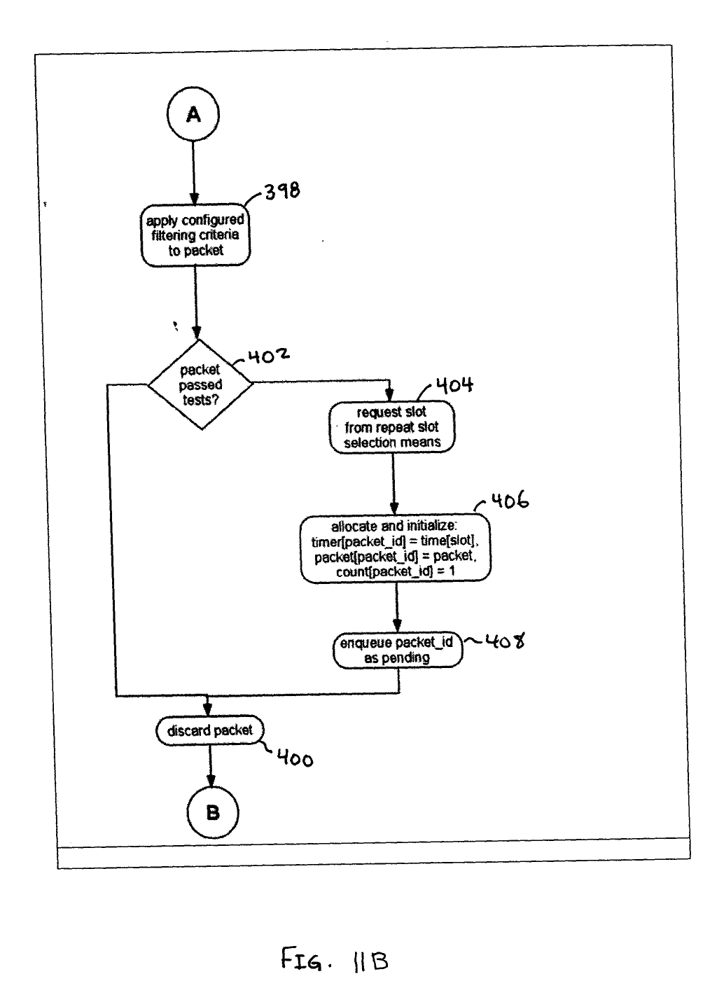

FIGS. 11A-11B show an embodiment of a process by which a node 50 determines whether to repeat a received packet. In step 390, the packet repeat decision component 336 waits for an event. Upon the occurrence of an event, the packet repeat decision component 336 determines (step 392) if the event is the timeout of the timer or the receipt of a packet.

If the event is a packet, the packet repeat decision component 336 determines (step 394) if the packet is an inbound packet (received from the network) or an outbound packet (to be transmitted to the network).

In general, if the packet is an inbound packet, and not a channel query or a channel query response, the packet repeat decision component 336 determines whether that packet is to be repeated, that is re-transmitted (or rebroadcast) over the network. In step 396, the packet repeat decision component 336 determines if the inbound packet (packet_id) is enqueued, indicating that the packet has been previously received and deemed suitable for retransmission. If the inbound packet is not enqueued, the packet repeat decision component 336 applies (step 398) configured filtering criteria to the packet. If the packet does not pass the criteria, the packet repeat decision component 336 discards (step 400) the packet. The criteria are based on a context specification currently bound to the multicast address and on the specific metadata associated with the inbound packet.

For example, situations can arise where a computing device 50 encounters “stray” packets, (e.g., from a neighboring classroom, and it is undesirable to have these stray packets pass through the present classroom into other classrooms. One technique for handling undesired packet traffic is to insure that neighboring classrooms use disjoint sets of multicast IP addresses. For this technique, the criteria used in each of the classrooms are to filtered out packets that have disallowed IP addresses. The technique requires coordination among the classrooms (i.e., the teacher or administrator) to assign the multicast IP addresses to their respective classrooms. Another technique is to include information in the packets that is unlikely to be common between neighboring classrooms. For example, such information can include the name of the teacher and the nature of the class (“Mrs. Brown's Fourth Period Algebra Class”). Accordingly, the packet repeat decision component 336 can be configured to “intelligently” filter undesired packets.

The application of such criteria is in addition to applying typical IP routing criteria such as the expiration of the time-to-live counter, malformed IP address, corrupt payload, etc.

If the inbound packet fails (step 402) any of the additional configured criteria, the packet repeat decision component 336 marks the packet as non-repeating and discards (step 400) the packet and any additional received copies.

If the packet passes the criteria (and other IP routing requirements), the packet repeat decision component 336 requests (step 404) a time slot from the repeat slot selection component 338 in which to retransmit the packet.

In one embodiment, the repeat slot selection component 338, the response slot selection component 334 chooses the time slot randomly upon each occurrence of a request for a time slot from the packet repeat decision component 336. Thus, the amount of time that a particular node 50 waits before re-transmitting the multicast packet varies for each multicast packet received. Again, this variable delay distributes the power consumed among the nodes 50 in the network.

In another embodiment, suitable for classes with small numbers of nodes 50, the slot is externally assigned—one per node 50 in the class, thus avoiding potential collisions. Slot assignments can be periodically rotated among the nodes 50 so that no node 50 bears more of the response burden, and consumes more battery power, than any other node 50.

Then in step 406 the packet repeat decision component 336 allocates and initializes the timer[packet_id]=time[slot], the packet[packet_id]=the packet, and the count[packet_id]=1. The packet repeat decision component 336 enqueues (step 408) packet_id as pending, discards (step 400) the packet, and returns to waiting (step 390) for the next occurrence of an event.

In brief overview, until the timer times out the packet repeat decision component 336 counts the number of copies of the inbound packet (including the original) received by the node 50. If the node 50 has received strictly fewer than the local connectivity number of copies when the timer times out, the packet repeat decision component 336 causes the packet to be transmitted (after first decrementing the counter and performing other normal packet retransmission operations).)

More specifically, if in step 396 the inbound packet is enqueued (indicating that the packet is waiting to be re-transmitted (i.e., pending) or has recently been re-transmitted or otherwise handled (i.e., completed)), the packet repeat decision component 336 discards (step 410) the inbound packet because there already is an enqueued copy. In step 450, the packet repeat decision component 336 determines if the enqueued packet is pending. If not pending, the packet repeat decision component 336 returns to waiting (step 390) for an event.

If the inbound packet is enqueued as pending, the packet repeat decision component 336 increments (step 414) the count for the inbound packet (e.g., packet_id (count[packet_id])). In step 416, the packet repeat decision component 336 compares the current count with the local connectivity number. If the count is less than the local connectivity number, the packet repeat decision component 336 returns to waiting (step 390) for an event. If the count equals the local connectivity number, the packet repeat decision component 336 deallocates (step 420) packet[packet_id[timer]], the timer[packet_id], and count[packet_id]. In step 422, the packet repeat decision component 336 dequeues the packet_id as pending and enqueues packet_id as completed. Then the packet repeat decision component 336 returns to waiting (step 390) for the occurrence of an event.

If in step 392 the event is the timeout of the timer, the packet repeat decision component 336 generates and transmits (step 428) a repeat packet from packet[packet_id[timer]], deallocates, dequeues, enqueues as set forth in steps 420 and 422, and returns to waiting (step 390) for the occurrence of an event.

If in step 394 the packet is an outbound packet, the packet repeat decision component 336 enqueues (step 424) packet id as completed and transmits (step 426) the packet. Then the packet repeat decision component 336 returns to waiting (step 390) for the occurrence of an event.

The networking mechanism described in FIGS. 8-11B includes two properties that help battery life. A first property, packets take short hops, and short distances between hops require less transmission power than longer distances. A second property, power consumption is distributed among the nodes 50 by causing the nodes 50, in effect, to take turns when responding to channel queries and when re-transmitting multicast packets.

Equivalents

The invention can be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. A method for providing a system of free-space electromagnetic pathways to facilitate wireless networking of computing devices, each computing device having a line-of-sight transceiver, the method comprising:
attaching a reflector to a surface of an object to create a reflective surface such that a beamed communication sent from a line-of-sight transceiver at a first location is reflected in a direction towards a second line-of-sight transceiver at a second location.

2. The method of claim 1 further comprising:
providing a first location within the system adjacent the reflector for a user of a first computing device; and
providing a second location within the system adjacent the reflector for a user of a second computing device.

3. The method of claim 1, wherein the reflector is a first reflector, further comprising:
attaching a second reflector to a surface of a second object to create a reflective surface such that the beamed communication received by the second transceiver and subsequently re-transmitted is reflected in a direction towards a third line-of-sight transceiver at a third location.

4. The method of claim 3 further comprising:
providing a third location within the system adjacent the second reflector for a user of a computing device.

5. The method of claim 1 wherein the step of attaching further comprises
attaching the reflector so that it has a curvature that disperses the beamed communication such that the second line-of-sight transceiver and a third the line-of-sight transceiver can receive the beamed communication.

6. The method of claim 5 further comprising transmitting the beamed communication using multicast packets.

7. The method of claim 5 further comprising transmitting the beamed communication in accordance to a multi-hop protocol.

8. The method of claim 1 further comprising providing the reflector that conforms to a curvature of the surface of the object.

9. The method of claim 1 further comprising providing the reflector shaped to produce a predefined curvature on the surface of the object.

10. The method of claim 9 wherein the step of providing the reflector further comprises providing the reflector with the predefined curvature being arcuate.

11. The method of claim 1 further comprising transmitting the beamed communication using light with an infrared wavelength.

12. The method of claim 1 further comprising using the computing device that is a personal digital assistant.

13. The method of claim 1 wherein the attaching step further comprises attaching the reflector to a chair.

14. A system of free-space electromagnetic pathways for facilitating wireless networking of a plurality computing devices, each computing device having a transceiver for beamed line-of-sight, electromagnetic communication, the communication channel comprising:
a first location at which one of the plurality of computing devices is used;
a second location at which another of the plurality of computing devices is used; and
a reflective surface purposely disposed adjacent the first and second locations such that a beamed communication transmitted from the first location is reflected in a direction towards the second location.

15. The system of claim 14 further comprising:
a third location at which another of the plurality of computing devices is used; and
a reflective surface purposely disposed adjacent the second and third locations such that the beamed communication received at and re-transmitted from the second location is reflected in a direction towards the third location.

16. The system of claim 15 wherein the beamed communication includes a multicast packet.

17. The system of claim 15 wherein the beamed communication traverses the network in accordance to a multi-hop protocol.

18. The system of claim 14 wherein the reflective surface has a curvature that disperses the beamed communication such that the beamed communication transmitted from the first location is received at the second location and the third location.

19. The system of claim 14 wherein the reflective surface conforms to a curvature of a surface of an object to which the reflective surface is attached.

20. The system of claim 14 wherein the reflective surface is shaped to produce a predefined curvature on a surface of an object to which the reflective surface is attached.

21. The system of claim 20 wherein the predefined curvature of the reflector is arcuate.

22. The system of claim 14 wherein the object is a chair.

23. The system of claim 14 wherein the beamed communication uses light with an infrared wavelength.

24. The system of claim 14 wherein the beamed communication uses microwaves.

25. The system of claim 14 wherein the computing devices are personal digital assistants.

26. A wireless network of line-of-sight computing devices, the network comprising:
a first computing device having a line-of-sight transceiver;
a second computing device having a line-of-sight transceiver; and
a reflector attached to a surface of an object adjacent the first and second computing devices such that a beamed communication sent from the transceiver of the first computing device is reflected in a direction towards the transceiver of the second computing device.

27. The wireless network of claim 26 further comprising:
a third computing device having a line-of-sight transceiver; and
a second reflector attached to a surface of a second object adjacent the second computing device such that the beamed communication received by the second computing device and subsequently re-transmitted by the second computing device is reflected in a direction towards the transceiver of the third computing device.

28. The wireless network of claim 27 wherein the beamed communication includes a multicast packet.

29. The wireless network of claim 27 wherein the beamed communication traverses the wireless network in accordance to a multi-hop protocol.

30. The wireless network of claim 26 wherein the reflector has a curvature that disperses the beamed communication such that the transceiver of the second computing device and the transceiver of a third computing device can receive the beamed communication.

31. The wireless network of claim 26 wherein the reflector conforms to a curvature of the surface of the object.

32. The wireless network of claim 26 wherein the reflector is shaped to produce a predefined curvature on the surface of the object.

33. The wireless network of claim 32 wherein the predefined curvature of the reflector is arcuate.

34. The wireless network of claim 26 wherein the beamed communication uses light with an infrared wavelength.

35. The wireless network of claim 26 wherein the computing devices are personal digital assistants.

36. The wireless network of claim 26 wherein the object is a chair.
